(19) United States
(12) Patent Application Publication
(10) Pub. No.: US 2026/0220995 A1
(43) Pub. Date: Jul. 30, 2026

(54) GAMING MACHINES WITH RADIAL CURVED DISPLAYS

(71) Applicant: LNW Gaming, Inc., Las Vegas, NV (US)

(72) Inventors: Joseph Lane SPINA, Henderson, NV (US); Michelle BRUBACK, Las Vegas, NV (US); Christian KULUJIAN, Chicago, IL (US)

(21) Appl. No.: 19/089,113

(22) Filed: Mar. 25, 2025

Related U.S. Application Data
(60) Provisional application No. 63/750,433, filed on Jan. 28, 2025.

(51) Int. Cl. G07F 17/32; G07F 17/34

(52) U.S. Cl. CPC G07F 17/3211; G07F 17/34

(57) ABSTRACT

A gaming machine associated with a player area includes a cabinet, an input deck coupled to the cabinet and extending towards the player area, and a presentation assembly coupled to the cabinet and oriented outward towards the player area. The presentation assembly includes a primary display device conically curved around a vertical axis extending through at least one of the cabinet or the input deck, the primary display device having a concave curvature relative to the player area. The primary display device includes a distal horizontal edge and a proximal horizontal edge positioned between the input deck and the distal horizontal edge, the distal horizontal edge having a length and a radial length relative to the vertical axis greater than a respective length and a respective radial length relative to the vertical axis of the proximal horizontal edge.

### CROSS-REFERENCE TO RELATED APPLICATIONS

This patent application claims the priority benefit of U.S. Provisional Patent Application Ser. No. 63/750,433, filed Jan. 28, 2025, the contents of which are incorporated herein by reference in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2025, LNW Gaming, Inc.

### Field of the Invention

The present invention relates to a technological improvement to gaming systems, gaming machines, and methods and, more particularly, to new and improved gaming machine features.

### BACKGROUND OF THE INVENTION

The gaming industry depends upon player participation. As the gaming industry grows, players seek new gaming experiences. The new gaming experiences may be found in new gameplay features and/or new mediums for playing games. For example, gaming machines provide a means for players to participate in gaming sessions, and the physical features of the gaming machines help shape the ways players can interface with the underlying game, such as how the game is visually presented, the manner in which the player provides player input, and the like. By improving the features and functionality of gaming machines, new gaming experiences and game functionality become available. Accordingly, there is a need in the gaming industry for further development and improvement of gaming machine technology.

### SUMMARY OF THE INVENTION

According to an embodiment of the present disclosure, a gaming machine associated with a player area includes a cabinet, an input deck coupled to the cabinet and extending towards the player area, and a presentation assembly coupled to the cabinet and oriented outward towards the player area. The presentation assembly includes a primary display device conically curved around a vertical axis extending through at least one of the cabinet or the input deck, the primary display device having a concave curvature relative to the player area. The primary display device includes a distal horizontal edge and a proximal horizontal edge positioned between the input deck and the distal horizontal edge, the distal horizontal edge having a length and a radial length relative to the vertical axis greater than a respective length and a respective radial length relative to the vertical axis of the proximal horizontal edge.

According to another embodiment of the present disclosure, a gaming system comprises a gaming machine and game-logic circuitry. The gaming machine is associated with a player area and includes a cabinet, an input deck coupled to the cabinet and extending towards the player area, and a presentation assembly coupled to the cabinet and oriented outward towards the player area. The presentation assembly includes a primary display device conically curved around a vertical axis extending through at least one of the cabinet or the input deck, the primary display device having a concave curvature relative to the player area. The primary display device includes a distal horizontal edge and a proximal horizontal edge positioned between the input deck and the distal horizontal edge, the distal horizontal edge having a length and a radial length relative to the vertical axis greater than a respective length and a respective radial length relative to the vertical axis of the proximal horizontal edge. The game-logic circuitry is in communication with the presentation assembly and configured to cause the primary display device of the presentation assembly to present game content of the game.

According to a further embodiment of the present disclosure, a method of assembly for a gaming machine is provided. The method comprises coupling an input deck to a cabinet of the gaming machine, the cabinet being associated with a player area occupiable by players for play of a game at the gaming machine and the input deck extending outward toward the player area, wherein the input deck defines an input surface configured to receive player input, and coupling a presentation assembly to the cabinet, the presentation assembly being oriented outwards towards the player area and including a primary display device having a distal horizontal edge and a proximal horizontal edge positioned between the input deck and the distal horizontal edge. The primary display device, with the presentation assembly coupled to the cabinet, is conically curved around a vertical axis extending through at least one of the cabinet or the input deck, the primary display device having a concave curvature relative to the player area. The distal horizontal edge has a length and a radial length relative to the vertical axis greater than a respective length and a respective radial length relative to the vertical axis of the proximal horizontal edge.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine, according to one or more aspects of the present disclosure.

FIG. 2 is a block diagram of a gaming system, according to one or more aspects of the present disclosure.

FIG. 3 is a block diagram of an example gaming machine according to one or more aspects of the present disclosure.

FIG. 4A is a perspective view of an example gaming machine according to one or more aspects of the present disclosure.

FIG. 4B is a front view of the gaming machine shown in FIG. 4A, according to one or more aspects of the present disclosure.

FIG. 4C is a side view of the gaming machine shown in FIG. 4A, according to one or more aspects of the present disclosure.

FIG. 5A is a top-down view of a conically curved presentation device, according to one or more aspects of the present disclosure.

FIG. 5B is a perspective top-down view of the conically curved presentation device shown in FIG. 5A, according to one or more aspects of the present disclosure.

FIG. 6 is a focused front view of the gaming machine shown in FIG. 4A with an output assembly, according to one or more aspects of the present disclosure.

FIG. 7 is a partial side view of the gaming machine shown in FIG. 4A with an internal subwoofer, according to one or more aspects of the present disclosure.

FIG. 8 is a perspective view of the gaming machine shown in FIG. 4A with the presentation assembly removed, according to one or more aspects of the present disclosure.

FIG. 9 is a perspective rear view of the output assembly of the gaming machine shown in FIG. 4A, according to one or more aspects of the present disclosure.

FIG. 10 is an exploded view of an aroma assembly of the output assembly shown in FIG. 9, according to one or more aspects of the present disclosure.

FIG. 11A is a perspective view of an example bank of gaming machines, according to one or more aspects of the present disclosure.

FIG. 11B is a top-down view of the bank of gaming machines shown in FIG. 11A, according to one or more aspects of the present disclosure.

FIG. 12 is a flow diagram of an example method of assembly for a gaming machine, according to one or more aspects of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

The following embodiments described herein relate to various gaming machine functionalities and the corresponding physical structures to provide said functionalities. For example, one or more embodiments described herein are directed to radial display configurations, audio configurations incorporating curved displays, sensory output assemblies, and/or swappable scent assemblies of a gaming machine. These features may be implemented together within a gaming machine or independently of each other to provide various gaming machine configurations and functionalities.

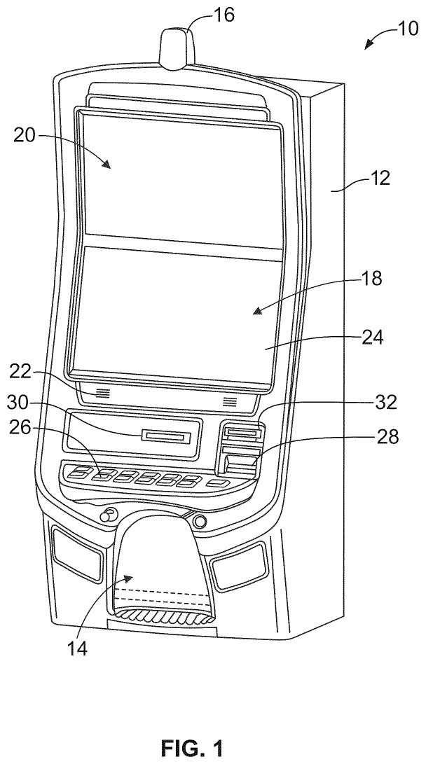

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter. The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter, the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

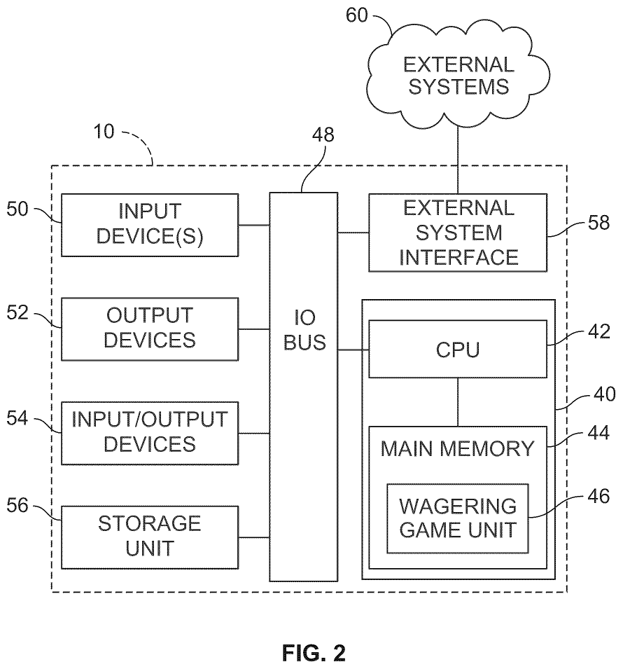

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success, and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S. A 5:12-23, 5:12-45, and all other relevant provisions of the New Jersey Casino Control Act. As can be seen from the description herein, the gaming machine 10 may be implemented with hardware and software architectures, circuitry, and other special features that differentiate it from general-purpose computers (e.g., desktop PCs, laptops, and tablets).

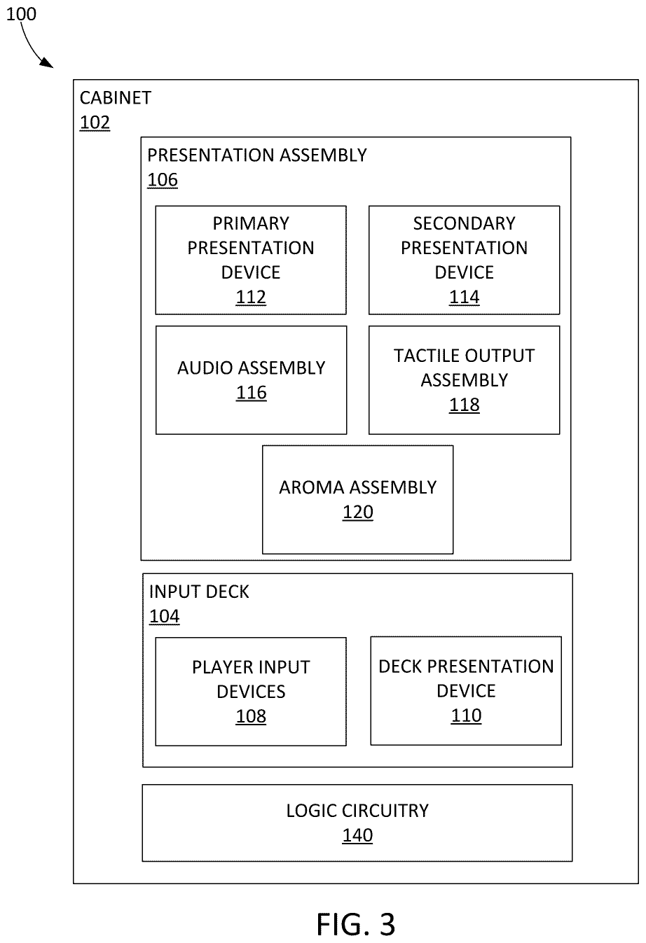

FIG. 3 is a block diagram of an example gaming machine 100 according to one or more aspects of the present disclosure. The gaming machine 100 may include components and/or functionality similar to the gaming machine 10 shown in FIGS. 1 and 2 unless otherwise noted. In the example embodiment, the gaming machine 100 includes a cabinet 102, an input deck 104, a presentation assembly 106, and logic circuitry 140. In other embodiments, the gaming machine 100 includes additional, fewer, or alternative components, including those described elsewhere herein.

The cabinet 102 of the gaming machine 100 is configured to mount and/or house various components of the gaming machine 100. For example, internal components (e.g., the logic circuitry 140) are housed within one or more internal cavities defined by the cabinet 102, while externally accessible components (e.g., the input deck 104 and the presentation assembly 106) are mounted to one or more mounting structures of the cabinet 102. The cabinet 102 may include both exterior walls and other structures as well as internal framework structures for mounting the components of the gaming machine 100. The cabinet 102 may be formed from a single component or a combination of components and subassemblies. In at least some embodiments, the cabinet 102 and/or the mounted componentry include physical structures that facilitate external access of the internal cavities of the gaming machine, such as a lockable maintenance door.

The cabinet 102 is configured to define various profiles of the gaming machine 100 based on the location of the attached components. For example, the cabinet 102 is configured to orient the input deck 104 and the presentation assembly 106 at a front profile of the gaming machine towards a player area in which one or more players are expected to reside during a gaming session at the gaming machine 100. The gaming machine 100 may be a floor-standing gaming machine similar to the machine 10 shown in FIG. 1, or the gaming machine 100 may be a different gaming machine configuration, such as a bartop machine or a handheld machine. The cabinet 102 and any coupled componentry is configurable to the corresponding gaming machine type.

The input deck 104 is coupled to the cabinet 102 and extends outwards towards the player area. The input deck 104 is configured to provide one or more player input devices 108 at which the player can provide input for play of a game or other suitable functionality of the gaming machine 100. For example, the input deck 104 may include one or more credit input devices for accepting and dispensing credit inputs and outputs, such as tickets, cards, bills, coins, and the like. In another example, the player input devices 108 may include one or more devices for interfacing with a player computing device (e.g., a player's cell phone), such as a Near-Field Communication (NFC) tag, Radio Frequency Identification (RFID) tag, wireless charging pad, data communication cable, and/or the like. In a further example, the player input devices 108 include one or more buttons, levers, joysticks, touchscreens, and/or other suitable means of providing player input to the gaming machine 100. In at least some embodiments, the input deck 104 includes one or more deck presentation devices 110. The deck presentation devices 110 may include, for example, an electronic display device (which may include a touchscreen from the player input devices 108), emotive lighting assemblies, a tactile feedback device for providing tactile outputs to the player, particularly in response to game events detected by the logic circuitry 140, and/or other suitable outputs for the gaming session.

In some embodiments, the gaming machine 100 may include a plurality of input decks 104. For example, the gaming machine 100 may include multiple input decks 104 to facilitate multiplayer gaming sessions. In another example, the functionality of the input deck 104 described above is split across several sub-decks to align with the physical configuration of the gaming machine 100.

The presentation assembly 106 is coupled to the cabinet 102 and configured to provide one or more sensory outputs to the player (or, more generally, to the player area) to convey various aspects of the gaming session, such as various events occurring within the underlying game. The presentation assembly 106 includes at least one visual output device to facilitate visual monitoring of the gaming session, though other suitable sensory output devices may be included as described herein. Although the presentation assembly 106 is described herein as a collective assembly of such devices, it is to be understood that the following devices and subassemblies may be divided into a plurality of presentation assemblies.

The presentation assembly 106 includes a primary presentation device 112, a secondary presentation device 114, an audio assembly 116, a tactile output assembly 118, and an aroma assembly 120. In other embodiments, the presentation assembly 106 includes additional, fewer, or alternative components, including those described elsewhere herein.

The primary presentation device 112 is coupled to the cabinet 102 such that the primary presentation device 112 is oriented towards the player area. The primary presentation device 112 is configured to visually present primary game content and/or other suitable visual features and functionality to the player. The primary presentation device 112 may be an electronic display configured to present graphical game interfaces. In certain embodiments, the primary presentation device 112 may be mechanical or electromechanical.

As described herein in greater detail in subsequent embodiments of the present disclosure, the primary presentation device 112 may be configured with a conical, concave curvature relative to the player area such that more display area can be readily visible to player without undue head and/or eye movements by the player relative to a flat display. The conical curvature gives the presentation device 112 a conical or funnel profile, where the presentation device 112 curves around an axis (e.g., a vertical axis) in a diagonal or angled configuration such that the radial lengths of opposing curved edges relative to the axis are substantially different.

The secondary presentation device 114 is coupled to the cabinet 102 and is configured to present secondary game content. The secondary presentation device 114 may be oriented towards the player area and/or other suitable areas surrounding the gaming machine 100. For example, the secondary presentation device 114 may be included within a topper assembly of the gaming machine 100 that is configured to present graphical content to bystanders, operators, maintenance workers, and the like. The secondary presentation device 114 may be configured to synchronize secondary game content with the primary game content of the primary presentation device 112. For example, a game interface may be presented across both of the presentation devices 112, 114 for play of a game. The deck presentation device 110, primary presentation device 112, and/or the secondary presentation device 114 may be positioned adjacent to each other to facilitate cross-device animations and/or presentation sequences, where game and/or presentation elements appear to move from one device to another.

Similar to the primary presentation device 112, the secondary presentation device 114 includes a concave curvature to enhance the display area visible to the player without undue head or eye movement. The conical curvature of the primary presentation device 112 may be matched or complemented by the curvature of the secondary presentation device 114, or the secondary presentation device 114 may be uniformly curved. In one example, the secondary presentation device 114 is positioned adjacent to a curved edge of the primary presentation device 112, and the secondary presentation device 114 is curved to substantially match the curvature of the adjacent edge of the primary presentation device 112.

In other embodiments, the presentation devices of the presentation assembly 106 may be in a different suitable configuration. In one example, the conically curved presentation device 112 may be incorporated into a topper assembly mounted above one or more primary displays of the presentation assembly 106. In another example, rather than a vertical, conical curvature, the presentation device 112 may be conically curved in a horizontal configuration around a horizontal axis or around another suitable axis (e.g., a diagonal axis defined at a 45° angle).

The audio assembly 116 is configured to generate audio output (e.g., music, sound effects, etc.) to align with the outputs of the presentation devices 112, 114. The audio assembly 116 includes one or more audio output devices (e.g., speakers, subwoofers, etc.) coupled to the cabinet 102. In some embodiments, at least one audio output device is oriented towards primary presentation device 112 (or the secondary presentation device 114) to facilitate an audio presentation for the player area. More specifically, the audio output of such devices reflects off of the surface of the primary presentation device 112, and the curved, conical nature of the primary presentation device 112 causes the angle of inflection to direct or converge the audio output outward from the primary presentation device 112—i.e., towards the player area. Accordingly, such audio output devices may be hidden or partially hidden from direct view from the player area while still providing the audio output of the presentation sequence of the presentation assembly 106.

Additionally or alternatively, the presentation devices of the presentation assembly 106 may be configured to obscure one or more audio output devices of the audio assembly 116 from direct view. For example, a subwoofer speaker outputs relatively low frequency audio output (e.g., bass), which is less susceptible to interference from intermediate objects between an audio source and a listener. The subwoofer speaker may be positioned within an internal cavity of the cabinet 102 behind the primary presentation device 112 and oriented towards the player area. The bass audio output travels through the primary presentation device 112 towards the player area without requiring the direct exposure of the subwoofer speaker to the player area. In some embodiments, the cabinet 102 and/or other components of the machine 100 define, when coupled together, one or more gaps that provide a channel for audio outputs to travel from the internal audio output devices to an external area around the machine 100, such as the player area. Additionally, particularly in combination with other audio output devices configured to direct audio through or towards the primary presentation device 112 (to be guided towards the player area), the emitted audio appears to align with the player's visual focus (i.e., the primary presentation device 112) to enhance the gaming experience.

In the example embodiment, the presentation assembly 106 includes the tactile output assembly 118 to facilitate emotive tactile sensory outputs to the player and/or other suitable observers or bystanders. The tactile sensory outputs may include, but are not limited to, air blasts and vibration outputs. The air blasts are guided air outputs (e.g., via one or more motorized fans, ducts, etc.) directed towards the player, such as towards the player's hands, to provide a tactile sensory effect in combination with the gameplay at the gaming machine 100. Similar to the audio assembly 116, the air blasts may be guided along the conical curvature of the primary presentation device 112 towards the player.

The vibration output may be one or more vibration motors integrated within the cabinet 102, the input deck 104, and/or other devices of the presentation assembly 106 (e.g., primary or secondary presentation devices 112, 114). The vibration motors are coupled with a physical structure that is in physical contact with the player to deliver vibrations from the motors to the player. Additionally or alternatively, the tactile output assembly may incorporate audio output devices from the audio assembly to provide vibration outputs. For example, the audio output of the internal subwoofer speaker of the audio assembly 116 described above may create vibrations through the cabinet 102 and/or the input deck 104 that can be sensed by the player. The subwoofer speaker can then be controlled to provide emotive tactile output to the player when synchronized with game content presented via the presentation devices 110, 112, 114.

The aroma assembly 120 is configured to provide another sensory output to be combined with game content of the gaming machine to provide a varied and unified presentation sequence for the gaming session. More specifically, the aroma assembly 120 is configured to provide one or more aromas or scents that are delivered to the player in combination with the game presentation at the gaming machine 100. For example, if a winning symbol combination of cherry symbols is detected within the game conducted by the gaming machine 100, a cherry scent is dispensed by the aroma assembly 120. The aromas may be stored through various suitable aroma mediums, such as scented oils, filters, waxes, sticks, aerosols, liquids, perfumes, and the like. The aroma assembly 120 is configured to store the aroma medium and selectively dispense the aroma. In some embodiments, the selective dispensing includes a delivery mechanism to output the aromas, such as a fan, duct, and the like. In certain embodiments, the aroma medium must be converted to another form prior to delivery to the player. In such embodiments the aroma assembly 120 includes one or more aroma activation devices, such as a heater to melt or evaporate an aroma medium, or a spray header to atomize the liquid aroma medium. In one or more embodiments, the fans of the tactile output assembly 118 may also be incorporated within the aroma assembly 120 to facilitate transmission of the aroma outputs to the player.

In the example embodiment, the various devices and assemblies of the gaming machine 100 are automated devices configured to operate through predefined computing instructions stored by one or more computing resources associated with the gaming machine 100 and various inputs detected via play of the game and/or sensors integrated with the gaming machine 100. The logic circuitry 140 (which may also be referred to herein as “game-logic circuitry 140”) is in communication with input deck 104 and the presentation assembly 106 to facilitate the automated actions of the gaming machine 100. For example, the player input devices 108 are in communication with the logic circuitry 140 to detect various inputs provided by the player during a gaming session. In another example, the presentation devices 110, 112, 114 of the gaming machine 100 are in communication with the logic circuitry 140 to receive game content and/or other suitable display content to be presented. The display content may be graphical images and/or control inputs to cause any mechanical structures of the presentation devices 110, 112, 114 to operate in according to the instructions of the logic circuity 140 (e.g., a mechanical reel spinning and stopping as defined by the logic circuity 140). In certain embodiments, the game-logic circuitry 140 is configured to conduct one or more games for the gaming machine 100.

The logic circuitry 140 may be substantially similar to the logic circuitry 40 (shown in FIG. 2) unless otherwise noted. The logic circuitry 140 may be at least partially integrated within the gaming machine 100 or within a wholly separate device in communication with the gaming machine 100. In embodiments in which the logic circuitry 140 is at least partially integrated into the gaming machine (such as FIG. 3), the logic circuitry 140 may be at least partially stored in a secured internal cavity of the cabinet 102 to prevent unauthorized access. The logic circuitry 140 may be a distributed system such that the functionality of the logic circuitry is performed by a plurality of computing devices in communication with each other.

In the example embodiment, the logic circuitry 140 is configured to synchronize various presentation outputs from the input deck 104 and the presentation assembly 106 in combination with the underlying gaming session to facilitate one or more unified presentation sequences. That is, as events occur in the gaming session and/or presentation outputs are generated from other presentation devices, the logic circuitry 140 is configured to ensure that each presentation output device is selectively activated to provide a corresponding output. For example, if the player has won an award during play of the game, the logic circuitry 140 transmits content and/or control instructions to the various output devices associated with the award, such as award sequence with graphical content to the presentation devices 110, 112, 114, an award audio output to the audio assembly, a tactile output via the tactile output assembly and an aroma output via the aroma assembly 120 aligned with the audiovisual outputs. By combining various outputs, the player experience is enhanced, potentially providing increased immersion into the gaming session. In the example embodiment, the logic circuitry 140 is configured to conduct the gaming session, including providing control data and commands to the presentation assembly 106. In other embodiments, the logic circuitry 140 is in communication with one or more computing devices configured to conduct the gaming session to operate the presentation assembly 106 in synchronization with the gaming session.

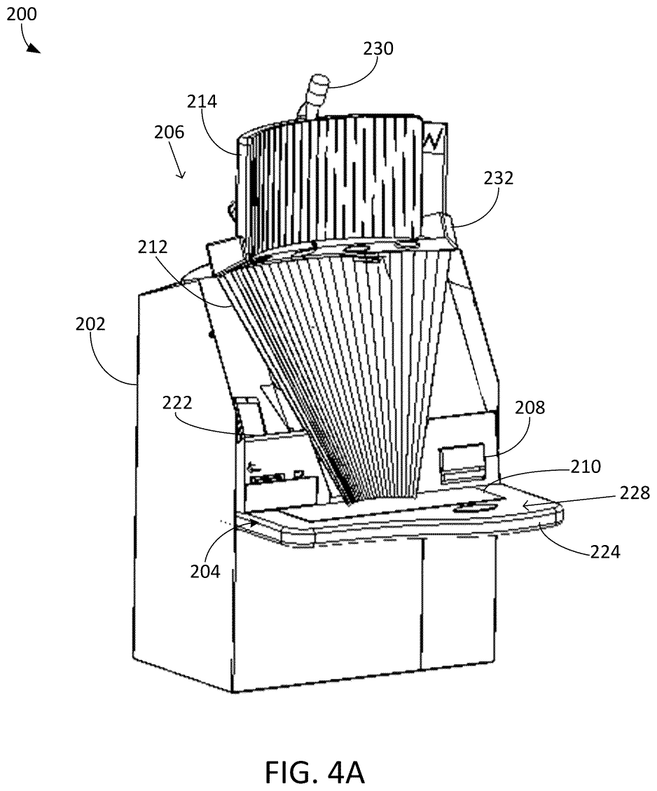

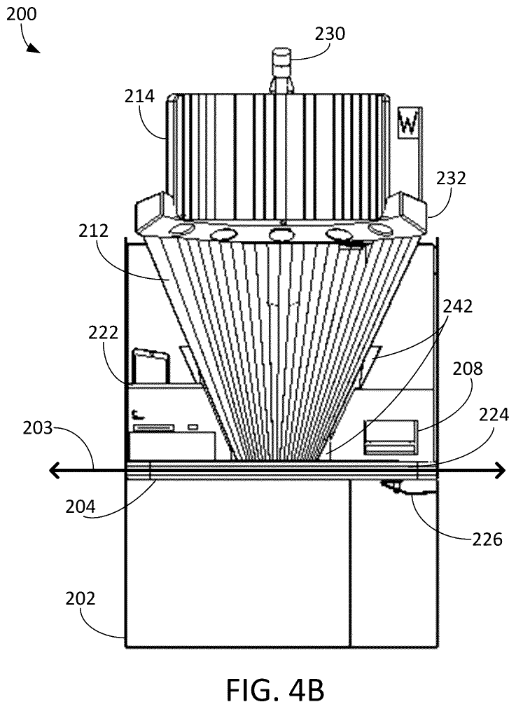

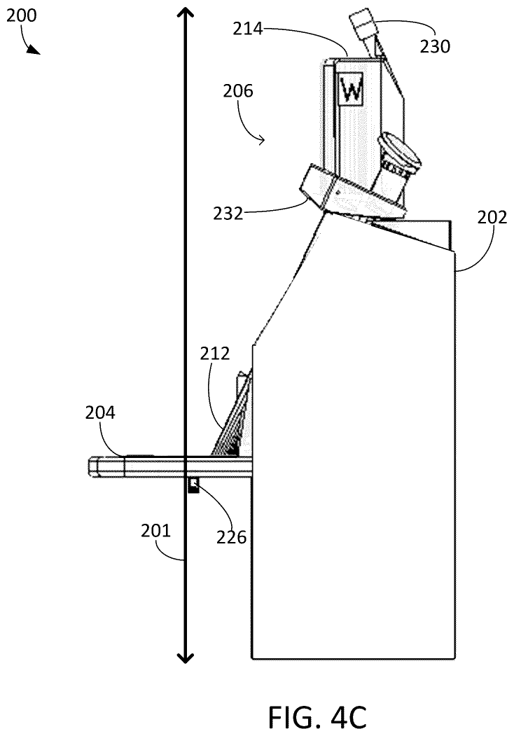

FIGS. 4A-4C depict an example gaming machine 200 according to one or more embodiments of the present disclosure. More specifically, FIG. 4A depicts a perspective view of the gaming machine 200, FIG. 4B depicts a front view of the machine 200, and FIG. 4C depicts a side view of the machine 200. The gaming machine 200 may be similar to the gaming machine 10 (shown in FIGS. 1 and 2) and the gaming machine 100 (shown in FIG. 3) unless otherwise specified. In the example embodiment, the gaming machine 200 includes a cabinet 202, an input deck 204, a presentation assembly 206, and a credit input device 208. In other embodiments, the gaming machine 200 includes additional, fewer, or alternative components in the same or alternative configurations, including those components and configurations described elsewhere herein.

With respect to FIGS. 4A-4C, the cabinet 202 provides structural support for the various components of the gaming machine 200 and provides one or more internal cavities to house various components of the gaming machine 200 from unauthorized access, such as logic circuitry (not shown in FIGS. 4A-4C), power supplies, and the like. In the example embodiment, the cabinet 202 includes an integrated phone holder 222 for a player to rest his or her phone while engaged in a gaming session at the gaming machine 200. It is to be understood that, although not shown, the cabinet 202 may include various mounting structures, fastener points, and the like to facilitate the mounting of the various componentry described herein.

The gaming machine 200 and the cabinet 202 are configured in a manner to provide various inputs and outputs of the gaming machine 200 (e.g., the presentation assembly 206) focused towards a player area. The player area is a region of space adjacent to the gaming machine 200 in which one or more players and/or close observers are expected to occupy during play of the gaming session. Generally, the player area is considered to the at the front of the machine 200. For example, FIG. 4B is oriented from the perspective of the player area. In some embodiments, one or more inputs and/or outputs of the gaming machine 200 may be presentable in other areas relative to the machine 200 in addition to or in place of the player area. For example, emotive lighting may be positioned along the sides and/or back of the cabinet 202 (where the “front” of the machine 200 faces the player area) to present emotive lighting beyond the player area.

The input deck 204 is coupled with the cabinet 202 and extends outwards towards the player area from the cabinet 202. A distal deck edge 224 extends towards the player area for the player to engage with the input deck 204. The physical profile of the input deck 204 and/or the distal deck edge 224 may take a different shape and/or configuration in other embodiments. In some embodiments, the input deck 204 includes a hook 226 for purses, bags, and/or other suitable hanging items. In other embodiments, additional, fewer, or alternative structures and components may be incorporated within the input deck 204, such as those described elsewhere herein. In one example, a drink holder may be integrated with the input deck 204. In certain embodiments, the phone holder 222 of the cabinet 202 may be integrated with the input deck 204 and/or the hook 226 may be integrated within the cabinet 202.

The input deck 204 is configured to provide various inputs and/or outputs accessible to the player, such as buttons, touchscreens, levers, and the like, for play of the gaming session and other suitable functionality of the gaming machine 200. In the example embodiment, the input deck 204 includes a deck presentation device 210 for presenting various graphical content, such as game content, to the player area. The deck presentation device 210 may include a touchscreen to facilitate receiving player input in addition to providing display output. At least some of the input and output devices of the input deck 204 are accessible via an input surface 228 defined by the input deck 204. Generally (and in the illustrated embodiment), the input surface 228 is the upward-facing surface of the input deck 204, though the input surface 228 may include other suitable surfaces of the input deck 204 in other embodiments.

In the example embodiment, the presentation assembly 206 includes a primary presentation device 212, a secondary presentation device 214, an indicator light 230, and an output assembly 232. In other embodiments, the presentation assembly 206 includes additional, fewer, or alternative components, including those described elsewhere herein.

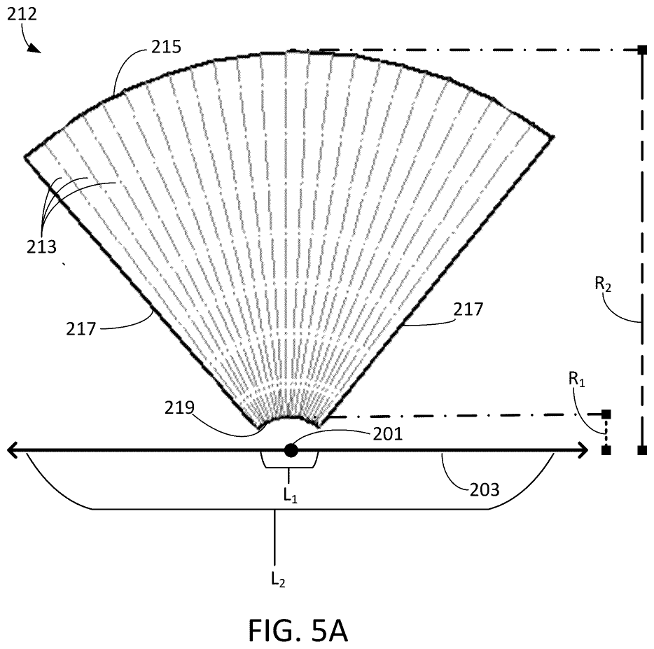

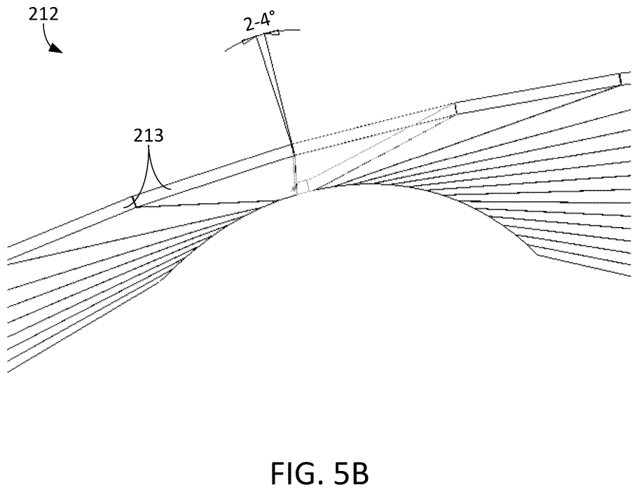

The primary presentation device 212 is an electronic display device configured to present graphical game content and/or other suitable graphical content associated with the gaming system including the gaming machine 200. The primary presentation device 212 has a conical or funnel-like curvature such that the two horizontal edges of the primary presentation device have at least partial elliptical curvature around a vertical axis defined through the gaming machine 200, such as vertical axis 201 shown in FIG. 4C. Accordingly, each horizontal edge of the primary presentation device 212 has a radial length (e.g., R₁ and R₂ in FIG. 5A) relative to the vertical axis 201, and the conical nature of the presentation device 212 yields different radial lengths for the horizontal edges (i.e., R₁ is less than R₂). That is, relative to a player in the player area, the primary presentation device 212 extends upward at an angle away from the player area (as seen in FIG. 4C). It is to be understood that the axis 201 may be defined elsewhere relative to the gaming machine 200 in other embodiments to provide different configurations of the primary presentation device 212. The conical curvature creates a downward tapered profile to the primary presentation device 212. In other embodiments, the conical curvature of the primary presentation device 212 may be rotated, either to create an upward tapered profile or to create a side-to-side tapered profile such that the conical curvature is defined around a horizontal axis in place of the vertical axis 201. In certain embodiments, the conically curved presentation device 212 may not be a primary presentation device. Rather, in such embodiments, the presentation device 212 may be a topper display, a secondary display, a deck display, and/or the like.

The unique curvature and, in some embodiments with a non-rectangular display panel, the uncommon aspect ratio of the primary presentation device 212 result in a unique environment for presenting game content and/or other suitable graphical content. The logic circuitry in communication with the primary presentation device 212 may store graphical data specifically generated for the primary presentation device 212 and/or include graphical data that is adjustable to be presentable on the presentation device 212 with limited or otherwise eliminated warping and other graphical artifacts. That is, the logic circuitry is configured to apply keystone functions and other graphical modification functions to underlying graphical data to facilitate proper presentation of the graphical elements on the primary presentation device 212.

In some embodiments, the primary presentation device 212 includes a flexible display panel that is formed into the illustrated shape through mounting structures and/or a display glass having a predefined shape. It is to be understood that “display glass” in this context refers to glass and other suitable transparent materials that protect the underlying display panel from external access while enabling light emitted by the display panel to pass through generally unimpeded. Other suitable materials include, for example, and without limitation, acrylic and plastic-based materials or coatings. The display panel may be, for example, an organic light-emitting diode (OLED) panel, a light-emitting diode (LED) panel, or a liquid-crystal display (LCD) panel.

In other embodiments, the primary presentation device 212 may be formed by a plurality of display segments or wedges that are coupled together to provide the curvature of the presentation device 212. More specifically, the display segments extend the vertical length of the presentation device 212 and are coupled together such that adjacent display segments may be angled relative to each other to form the overall curvature of the presentation device 212. The angled coupling may be achieved through hinged or otherwise curved mounting structures upon which each display segment is coupled to each other and/or the cabinet 202. In some embodiments, each display segment (or a single, flexible display panel) are mounted to a mounting structure formed by a plurality of angled mounting segments coupled together at an angle. In other embodiments, the mounting structure may be a single structure that is curved or bent such that mounting the display segments or the flexible display panel forms the overall curvature of the primary presentation device 212.

FIG. 5A depicts a top-down view of the primary presentation device 212 according to one or more aspects of the present disclosure. In particular, the primary presentation device 212 includes a plurality of display segments 213 that are coupled together in an angled configuration to define the collective curvature of the primary presentation device 212. The display segments 213 may be independent displays that, when operated together by a display controller (e.g., the logic circuitry 40 or 140, shown in FIGS. 2 and 3), can present composite graphical content over the plurality of segments 213. In other embodiments, the display segments 213 are not independent displays, but rather are angled mounting structures to which a single flexible display panel and corresponding display glass are mounted to form the curvature of the primary presentation device 212. In further embodiments, the curvature of the primary presentation device 212 is not formed through angled coupling of segments, but rather is defined by a single, curved set of display components and corresponding mounting structures.

In the example embodiment, each of the display segments 213 is in a wedge configuration, where each segment have substantially the same length vertical edges, but different lengths or arc lengths for the opposing horizontal edges. The wedge configuration, similar to segments of a circle, aid the angled, conical curvature of the primary presentation device 212. In other embodiments, the display segments 213 are substantially rectangular. In either embodiment, the curvature of the primary presentation device is the result of minor changes to the angle of each adjacent display segment 213. These “micro-bends” at each junction of adjacent display segments 213 may be, for example, within the range of two to four degrees (inclusive), where the micro-bends near the edges of the primary presentation device is lower relative to the micro-bends near the middle of the primary presentation device to yield the conical curvature. That is, the micro-bend between two adjacent outer display segments 213 may be two degrees while the micro-bend between two adjacent inner display segments 213 may be four degrees. FIG. 5B is a top-down perspective view of the display segments 213 of the primary presentation device 212 illustrating the micro-bend between adjacent display segments 213, thereby resulting in the overall curvature of the presentation device 212. It is to be understood that the display segments 213 may be coupled together in a different angled configuration, including a configuration in which the angle between adjacent display segments is lower than two or greater than four.

FIG. 5A includes the vertical axis 201 and the horizontal axis 203 relative to the primary presentation device 212. The vertical axis 201 is illustrated as a point because the vertical axis 201 extends orthogonally to the plane captured in FIG. 5A as seen in FIG. 4C. Relative to the input deck 204 shown in FIGS. 4A-4C, the primary presentation device 212 includes a distal horizontal edge 215, a pair of vertical edges 217, and a proximal horizontal edge 219 positioned between the distal horizontal edge 215 and the input deck 204 relative to the vertical axis 201. The curvature of the primary presentation device 212 around the vertical axis 201 yields a first radial length R₁ for the proximal horizontal edge 219 and a second radial length R₂ for the distal horizontal edge 215. The conical curvature of the primary presentation device 212 results in the first radial length R₁ to be less than the second radial length R₂.

Similarly, relative to the horizontal axis 203, the proximal horizontal edge 219 has a first horizontal length L₁ and the distal horizontal edge 215 has a second horizontal length L₂, where the first horizontal length L₁ is less than the second horizontal length L₂. It is to be understood that the horizonal lengths are relative to the horizontal axis 203 and does not refer to the arc length of each horizontal edge 215, 219. The proximal horizontal edge 219 may have an arc length that is the same or less than the arc length of the distal horizontal edge 215. In embodiments in which the arc lengths are the same, the difference in horizontal lengths L₁ and L₂ are yielded through the conical curvature defined by the primary presentation device 212.

With reference again to FIGS. 4A-4C, the secondary presentation device 214 is a graphical display device positioned above the primary presentation device 212 and is configured to present graphical game content and/or other suitable content associated with the gaming session and the gaming system including the gaming machine 200. In the example embodiment, the secondary presentation device 214 is curved in a concave configuration relative to the player area. The curvature of the secondary presentation device 214, in contrast to the primary presentation device 212, is cylindrical and results in similar radial lengths of the two horizontal edges of the secondary presentation device 214 from a vertical axis defined through the gaming machine 200, such as the axis 201. In other embodiments, the secondary presentation device 214 may include another suitable configuration within the gaming machine 200, such as a conical curvature or different location on the gaming machine 200 relative to the primary presentation device 212.

In the example embodiment, the deck presentation device 210, the primary presentation device 212, and the secondary presentation device 214 are positioned adjacent to each other. The adjacency of the various presentation devices, particularly graphical display devices, facilitates synchronized graphical presentations that appear to flow from one presentation device to another. For example, graphical elements appear to travel downward from the secondary presentation device 214 may appear to flow down onto the primary presentation device 212 and subsequently the deck presentation device 210. In other embodiments, additional or alternative presentation devices may be incorporated into such a cross-device presentation sequence, such as emotive lighting positioned adjacent to the presentation devices 210, 212, 214.

To facilitate the cross-device presentation, the logic circuitry in communication with the presentation devices 210, 212, 214 is configured to adjust the stored graphical data to generate graphical elements that match each of the presentation devices 210, 212, 214 given the differences in form factor, curvature, and potentially resolution between adjacent devices. In one example, the logic circuitry stores the same graphical data for all of the presentation devices 210, 212, 214 and performs graphical manipulation functions to generate the corresponding graphical elements for each device 210, 212, 214, such as a keystone function that calculates the perspective difference between adjacent presentation devices and converts the graphical data as a function of the calculated difference. In another example, the different graphical elements for each presentation device 210, 212, 214 are predefined and stored by the logic circuitry for subsequent presentation sequences.

The indicator light 230 is positioned above the secondary presentation device 214. The indicator light 230 is configured to emit light to facilitate alerting operators associated with the gaming machine 200 of certain events, such as a high-value award requiring assistance occurring or maintenance is required for the machine 200. In some embodiments, the indicator light 230 may be integrated within certain presentation sequences of the presentation assembly 206 beyond conveying information to operators and other bystanders.

The output assembly 232 is mounted to the cabinet 202 above the primary presentation device 212. The secondary presentation device 214 is coupled to or otherwise adjacent to the output assembly 232 such that the secondary presentation device 214 at least partially obscures the output assembly 232 from the player area while positioning the secondary presentation device 214, from the perspective of the player in the player area, adjacent to the top of the primary presentation device 212. The output assembly 232 is configured to house one or more output devices of the presentation assembly 206 to facilitate one or more presentation outputs, such as visual, audible, aromatic, and/or tactile outputs for the player and/or other suitable bystanders in the player area or other areas near the gaming machine 200. FIG. 6 depicts focused perspective view of the gaming machine 200 to reveal several components of the output assembly 232.

With reference to FIGS. 4A-4C and 6, the output assembly 232 includes an assembly housing 234, three speakers 236, and a pair of aroma assemblies 238. In other embodiments, the output assembly 232 includes additional, fewer, or alternative components in the same or different configuration, including components and/or configurations described elsewhere herein. In one example, the output assembly 232 includes a different number of speakers 236 and/or aroma assemblies 238.

The assembly housing 234 is integrated with the cabinet 202 or is otherwise secured to the cabinet and/or other mounting structures (e.g., the mounting structures of the presentation devices 212, 214). In the example embodiment, the assembly housing 234 follows the curvature of the secondary presentation device 214. In other embodiments, the assembly housing 234 may follow the curvature of the primary presentation device 212 or have a curvature different from either presentation device 212, 214, which may include embodiments in which the housing 234 has no curvature. The assembly housing 234 is configured to mount and/or house components of the output assembly 232 to facilitate the intended outputs. For example, the speakers 236 are secured to the housing 234 via an opening to facilitate audio output to the player area, and the housing 234 houses various power and/or control components for facilitating the output from the speakers 236.

The speakers 236 are oriented to face the primary presentation device 212 and provide audio outputs according to one or more presentation sequences of the gaming machine 200. More specifically, the speakers 236 are oriented to generate an audio output towards the primary presentation device 212 to be reflected or otherwise guided towards the player area based on the conical curvature of the primary presentation device 212 and the angle of incidence resulting from the relative orientations of the speakers 236 and the primary presentation device 212. As a result, the audio output as observed by a player in the player area may appear to originate from the primary presentation device 212, which is typically the visual focus of the player during a gaming session at the gaming machine 200 and facilitates a unified audiovisual presentation sequence. Moreover, the speakers 236 are spaced apart along the assembly housing 234 to facilitate different audio channels and/or to facilitate a wider range of audio output to the player area. That is, the angles of incidence from the reflected audio spans a greater physical area with the speakers 236 space apart rather than positioning the speakers 236 directly next to each other. In certain embodiments, the speakers 236 may be positioned together along the assembly housing 234 but are oriented at different angles to provide different angles of incident along the primary presentation device 212.

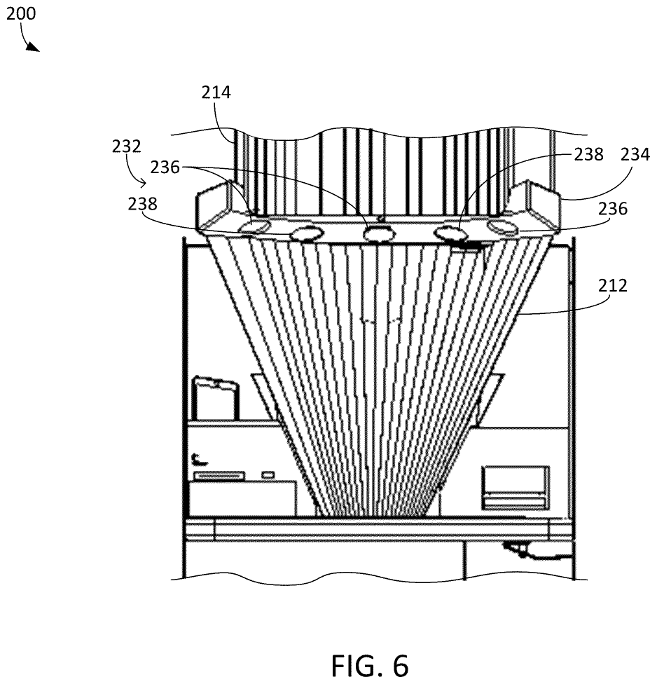

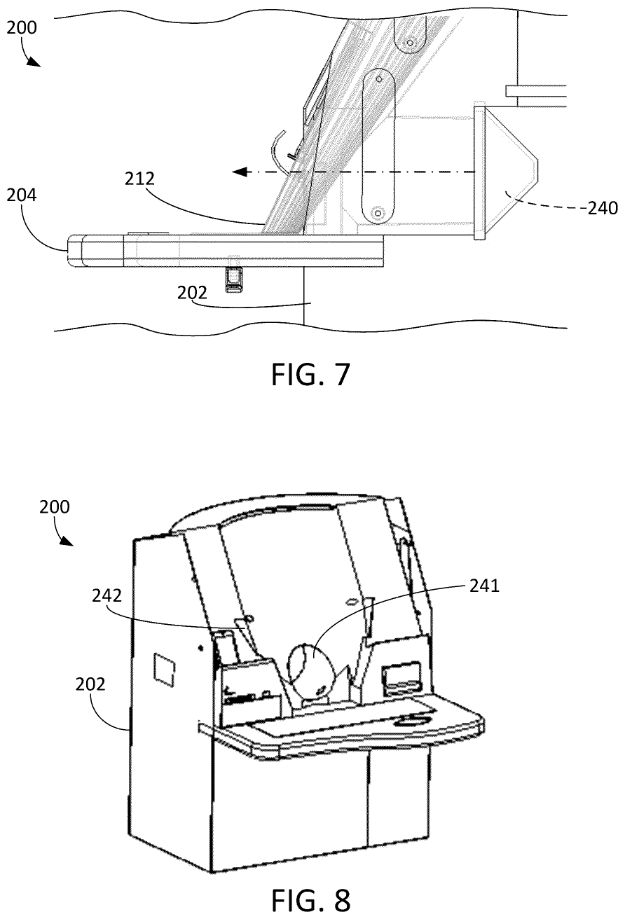

In the example embodiment, in addition to the speakers 236, the presentation assembly 206 is configured to include an internal subwoofer 240, shown in FIG. 7. FIG. 7 depicts a partial internal side view of the gaming machine 200 with the internal subwoofer 240. The subwoofer 240 is secured within an internal cavity of the cabinet 202 or is hidden from player view by the primary presentation device 212. FIG. 8 depicts the gaming machine 200 with the presentation assembly 206 removed, thereby exposing an area behind the primary presentation device 212. The cabinet 202 includes an opening 241 for housing the subwoofer 240 and/or guiding audio from the subwoofer 240 outwards the player area. The subwoofer 240 is configured to generate an audio output that is transferable through the primary presentation device 212 and/or other suitable openings around the primary presentation device 212. For example, gaps may be defined between the vertical edges of the primary presentation device 212 and the cabinet 202 to facilitate a path for the audio output towards the player area. FIG. 8 (and FIG. 4B) depicts several gaps 242 defined between the primary presentation device 212 and the cabinet 202 such that audio outputs form the subwoofer 240 are guided to and out of the gaps 242 towards the player area. Additionally, the subwoofer 240 is configured to output audio at lower frequencies, which may be transferable through physical barriers (i.e., the primary presentation device 212). The audio output may cause the primary presentation device 212 and/or the input deck 204 (through contact with the cabinet 202 and/or the primary presentation device 212) to vibrate, potentially creating an additional tactile output to the player if the player is resting upon the gaming machine 200.

The output assembly 232 includes two aroma assemblies 238 to facilitate aroma or scent-based outputs to be incorporated into one or more presentation sequences. In some embodiments, the aroma assemblies 238 may also provide a tactile output be generating a guided air stream towards the player and/or the player area. In one example, the guided air stream facilitates distribution of a predefined aroma and is directed to an area in which the player's hands are expected to be located (e.g., resting on the input deck 204). In other embodiments, the gaming machine 200 includes separate assemblies for providing a tactile air output and an aroma output.

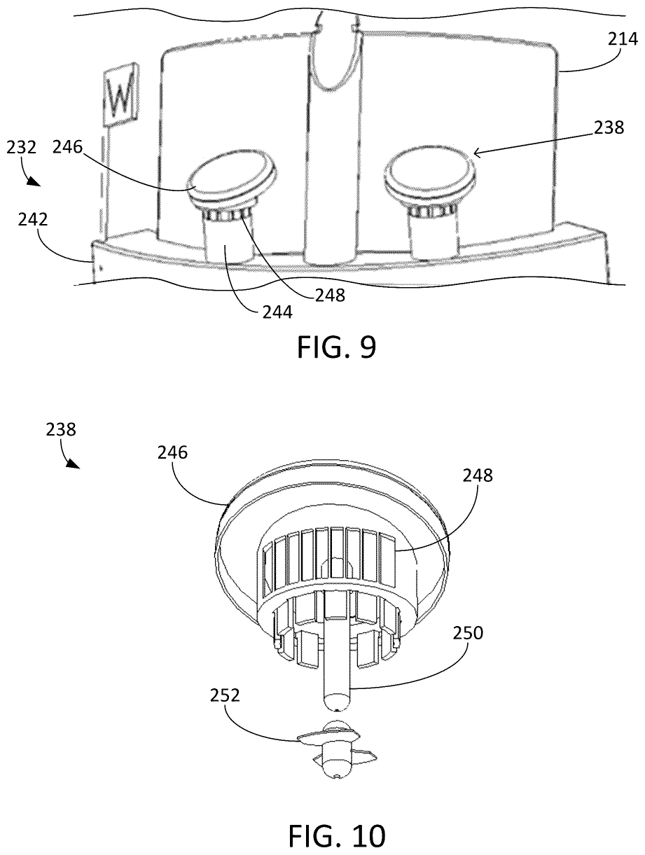

FIG. 9 depicts a rear partial view of the gaming machine 200 focused on the output assembly 232, and FIG. 10 depicts an exploded view of the aroma assembly 238. The assembly housing 234 includes a pair of aroma assembly bodies 244 that extend upward to house the components of the aroma assembly 238. Each of the aroma assemblies 238 includes a cap 246, a grill opening 248, a scent filter 250, and a fan 252. In other embodiments, the aroma assemblies includes additional, fewer, or alternative components, including those described elsewhere herein.

The cap 246 is configured to obscure the internal components of the aroma assembly 238. For example, the cap 246 may provide protection against liquid egress from above the aroma assembly 238. The cap 246 also provides a means for an operator to easily replace or otherwise access internal components of the aroma assembly 238. For example, the scent filter 250 may be replaced with a new filter 250 by removing the cap 246 from the aroma assembly body 244. The scent filter 250 may be integrated with the cap 246 such that the cap 246 is replaced with the filter 250. In some embodiments, rather than a fully removeable cap 246, access to the internal components of the aroma assembly 238 may be provided via hinged covers or fully removable aroma assemblies 238.

The cap 246 includes the grill opening 248. In some embodiments, the grill opening 248 is at least partially defined within the aroma assembly body 244. That is, in one example, both of the body 244 and the cap 246, when coupled together, form the grill opening. The grill opening 248 provides an opening through the cap 246 to intake air for the guided air stream. In some embodiments, the grill opening 248 may include one or more filters to remove particulates and other debris from the intake air. Additionally or alternatively, the aroma assembly 238 may include an intake air system to facilitate increased air intake and/or provide air intake in configurations which may not otherwise intake sufficient air passively to provide the functionality of the aroma assembly 238 as described herein. For example, one or more fans or compressor pumps may be used at or in combination with the grill opening 248 to enhance air intake of the aroma assembly 238.

The scent filter 250 is configured to provide a predefined aroma that can be dispensed via a guided stream of air to the player area. The scent filter 250 may use passive and/or active mechanisms for dispensing an aroma output. In one example, the aroma passively emanates into the surrounding air through contact with the scent filter 250. The aroma may be selectively dispensed by selectively exposing the scent filter 250 to the air stream through a removable cover, barrier, and/or the like. In another example, the aroma is dispensed in response to an active mechanism, such as a heater applied to an aroma medium (e.g., the scent filter 250), or an atomizer spray nozzle dispensing an aroma output to the air stream. In certain embodiments, the aroma assembly 238 may be configured to selectively dispense a plurality of aromas by selectively activating different aroma mediums. In one example, the aroma assembly 238 may include a motorized carousel of scent filters 250 that is rotatable to expose one or more scent filters 250 into the air stream through the assembly 238 or otherwise expose the scent filters 250 to a dispensing mechanism (e.g., heater, spray nozzle, etc.). In another example, the aroma assembly 238 includes a plurality of aroma activation devices that are selectively and independently controllable to dispense certain aromas based on which aroma activation devices are used.

The fan 252 is configured to generate an air stream through the aroma assembly 238 and guide the air stream out to the player area as described herein. In the example embodiment, the fan 252 is a vane axial fan secured within the aroma assembly body 244 between the scent filter 250 and the opening shown in FIG. 6 such that air is pulled from the grill opening 248 past the scent filter 250 and out towards the player area as described herein. In other embodiments, other suitable configurations of fans may be used to facilitate the air stream, including other types of fans and/or additional fans. In certain embodiments, additional or alternative devices may be used to aid or otherwise generate the air stream, such as a compressor.

The fan 252 is selectively controlled (e.g., by the logic circuitries 40 or 140 shown in FIGS. 2 and 3, respectively) to provide the air stream in choreography with events occurring in the gaming session and/or other presentation outputs of the gaming machine 200. For example, a particular scent may be dispensed via the activating the fan 252 (and the scent filter 250) for a winning symbol combination. In another example, an explosion occurring within the presentation of the gaming machine 200 may cause the logic circuitry to initiate a blast of air at the player in combination with the audiovisual presentation of the explosion to further enhance the player immersion within the gaming session.

In the example embodiment as shown in FIG. 6, similar to the speakers 236, the aroma assemblies 238 are configured to output air blasts and aromas downwards relative to the output assembly 232. The aroma assemblies 238 may be oriented to direct the air and/or aromas at the primary presentation device 212 to be reflected at the player area, or the aroma assemblies 238 may be oriented towards the player area directly. In one example, the aroma assemblies 238 are oriented to direct air streams towards the input deck 204 where a player's hands may be located to provide the tactile output of the air blast. In such an example, the aroma assemblies 238 are positioned within the assembly housing 234 to orient the air streams towards the player's hands during typical use of the gaming machine 100. Moreover, by guiding the air in front of the player, any carried aromas are dispensed within the vicinity of the player's nose to smell the aroma.

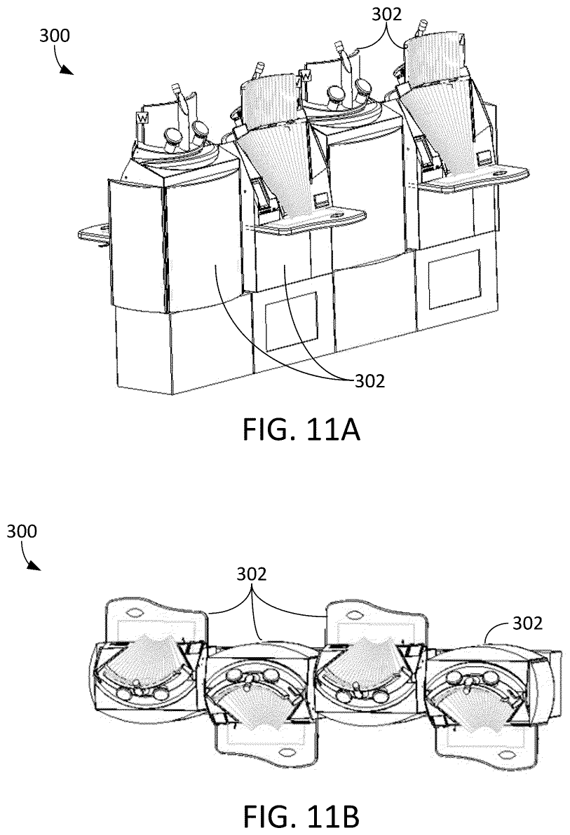

FIGS. 11A and 11B depict an example bank 300 of gaming machines 302 according to one or more embodiments of the present disclosure. More specifically, FIG. 11A depicts the gaming machine bank 300 from a perspective view, and FIG. 11B depicts the bank 300 from a top-down view. The bank 300 includes four gaming machine 302 arranged adjacent to each other in an alternating configuration in which each adjacent machine 302 is rotated 180 degrees relative to each other. In other embodiments, the bank 300 may include additional or fewer machines 302 and/or arrange the gaming machine 302 in an alternative configuration.

The bank configuration shown in FIGS. 11A and 11B may be beneficial for different floor layouts of gaming environments relative to bank configurations of traditional gaming machines. For example, the bank configuration may be beneficial for deploying multiple gaming machines 302 between two parallel walkways in which potential players pass by the bank 300. The curvature of the displays and the body of the machines 302 enable the alternating bank configuration without adjacent players being in direct view with each other while reducing the overall footprint of the bank 300 relative to similar bank configurations attempting to attract players from different sides of the bank 300.

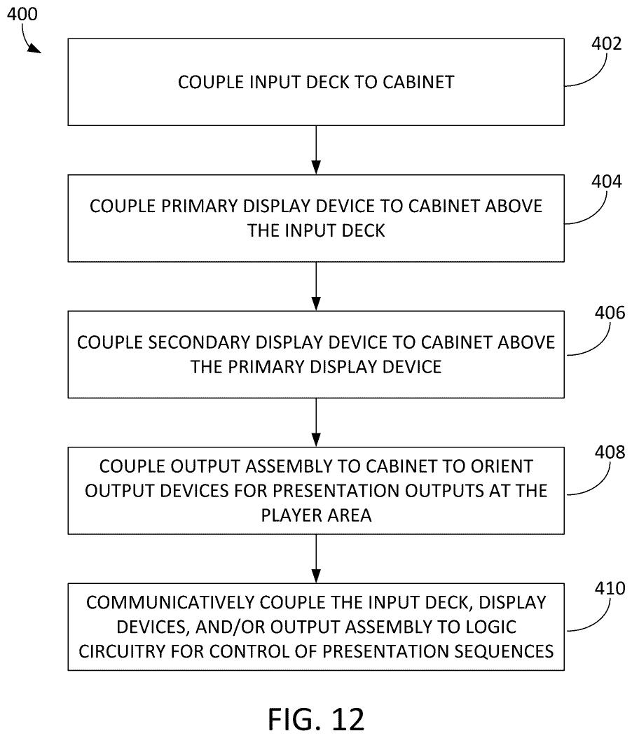

FIG. 12 depicts a flow diagram of an example method 400 of assembling a gaming machine according to one or more aspects of the present disclosure. The gaming machine may be the same as or similar to the machine 100 (shown in FIG. 3) and/or the machine 200 (shown in FIGS. 4A-10). In other embodiments, the method 400 may include additional, fewer, or alternative steps, including those described elsewhere herein.

At step 402, an input deck is coupled to a cabinet of the gaming machine such that the input deck extends outward towards a player area. The input deck may include a deck display device that may be incorporated into game content and/or other suitable content presented by the gaming machine. The input deck may define one or more horizontal or vertical axis that may be used for orientating various components of the gaming machine relative at least partially to the input deck. For example, a vertical axis may extend orthogonally to an input surface defined on top of the input deck, or a horizontal axis may be defined through the input deck or tangentially past a distal deck edge of the input deck, where the distal deck edge is positioned away from the cabinet of the gaming machine.

The method 400 continues with coupling a presentation assembly of the gaming machine to the cabinet. In the example embodiment, steps 404-408 are associated with installing various components of the presentation assembly. In other embodiments with different presentation assembly configurations (e.g., more or less display devices and/or output assemblies), the method 400 is adaptable to fit the corresponding physical structures of the presentation assembly.

At step 404, a primary display device is coupled to the cabinet above the input deck. It is to be understood that “above” in this context still encapsulates configurations in which, relative to a vertical axis, a highest point of the input deck may be greater than a lowest point of the primary display device but lower than a respective highest point of the primary display device (i.e., the input deck does not, in its entirety, need to be positioned below the lower limits the primary display device. The primary display device is conically curved such that the primary display device has a concave curvature relative to the player area. The conical curvature provides a tapered profile to the primary presentation device, where the opposing vertical edges taper at an angle from one horizontal edge to the opposing horizontal edge of the primary display device. In some embodiments, the horizontal edges have substantially the same length, yet appear to be different horizontal lengths relative to a horizontal axis defined through the sides of the cabinet and/or the input deck (or tangentially across the distal deck edge) based on the angle of the primary display device and different curvatures at the horizontal edges, thereby yielding different radial lengths at the horizontal edges relative to the vertical axis around which the primary display device is conically curved. In other embodiments, in addition to or in place of the differences above, the horizontal edges may have different lengths to yield the conical curvature.

At step 406, a secondary display device of the presentation assembly is coupled to the cabinet. More specifically, the secondary display device is coupled above the primary display device. The secondary display device may share or complement the curvature of the primary display device, or the secondary display device may have a different curvature, including embodiments in which the secondary display device is substantially flat. In certain embodiments in which the upper or distal horizontal edge of the primary display device is adjacent to a horizontal edge of the secondary display device, the secondary display device may be curved to match the curvature of the upper horizontal edge of the primary display device.

At step 408, an output assembly is coupled to the cabinet to orient one or more output devices to provide presentation outputs towards the player area. The outputs are sensory outputs that may be detected by the player at the gaming machine during a gaming session and/or bystanders passing by the gaming machine when deployed. In one example, audio output devices, such as speakers, may be incorporated into the output assembly. In another example, a scented air blast assembly may be used to selectively generate scents and/or air blasts for the player. In some embodiments, the output devices are oriented to directly output at the player area. In other embodiments, at least one output device is oriented towards the primary presentation device to provide an indirect output to the player area. That is, the angle and curvature of the primary presentation device creates angles of incidence that reflect or otherwise guide outputs such as sound and/or air streams towards the player area.

Although direct pathways for these presentation outputs may be ideal for each device when considered in isolation, the indirect pathways have several advantages. For example, visually obscuring certain portions of the output assembly can be performed through visually pleasing or functional components oriented at the player area, such as the secondary display device. In another example, the primary presentation device is generally a focal point of the player's attention during play of a game, and the guided outputs may be perceived as originating from the primary display device, thereby enhancing the immersion of the player in the gaming session. Moreover, visually obscuring the output devices may cause the player to disassociate the outputs from the corresponding output device such that the player perception of the outputs is not a plurality of discrete, independent devices, but rather the unified presentation sequence as a whole.

In some embodiments, the output assembly is secured to the cabinet as a whole assembly. In other embodiments, each output device may be coupled to one or more housings of the output assembly to form the assembly as a whole. For example, aroma assemblies may be selectively added and removed from the output assembly to facilitate replacing aroma mediums. In certain embodiments, the output assembly includes predefined slots, mounting positions, and the like that may be used to receive a plurality of output device types, thereby creating various output device configurations available for the output assembly. In certain embodiments, the output devices are not limited to the output assembly. For example, a subwoofer speaker may be incorporated into the cabinet separate from the output assembly and housed behind the primary display device.

At step 410, the logic circuitry of the gaming machine is communicatively coupled to the various presentation devices of the presentation assembly (e.g., the primary and secondary display devices and the output assembly) to coordinate unified presentation sequences. That is, the various presentation outputs of the gaming machine are selectively controllable to generate outputs in response to control inputs from the logic circuitry, and the logic circuitry initiates presentation sequences that activate the various presentation outputs on a predefined choreography. To the player and bystanders, the controlled presentation outputs help form a unified sensory experience received from the gaming machine. When the presentation sequences are incorporated into events occurring within a gaming session (or while the gaming machine is in an attraction state awaiting a new gaming session), the presentation outputs provide enhanced immersion into the gaming experience.

In this description, numerous specific details are set forth. However, it is understood that embodiments of the invention may be practiced without these specific details. In other instances, well-known circuits, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming machine comprising:
a cabinet associated with a player area occupiable by players for play of a game at the gaming machine;
an input deck coupled to the cabinet and extending towards the player area, the input deck defining an input surface configured to receive player input; and
a presentation assembly coupled to the cabinet and oriented outward towards the player area, the presentation assembly comprising:
a primary display device conically curved around a vertical axis extending through at least one of the cabinet or the input deck, the primary display device having a concave curvature relative to the player area, and
wherein the primary display device has a distal horizontal edge and a proximal horizontal edge positioned between the input deck and the distal horizontal edge, the distal horizontal edge having a length and a radial length relative to the vertical axis greater than a respective length and a respective radial length relative to the vertical axis of the proximal horizontal edge.

2. The gaming machine of claim 1, wherein the input surface includes an input display device, and the proximal horizontal edge of the primary display device is positioned adjacent to the input display device.

3. The gaming machine of claim 1, wherein the presentation assembly includes a secondary display device including a secondary distal horizontal edge and a secondary proximal horizontal edge, the secondary display device having a concave curvature relative to the player area, and wherein the secondary distal horizontal edge and the secondary proximal horizontal edge have substantially matching lengths.

4. The gaming machine of claim 3, wherein the secondary distal horizontal edge is positioned adjacent to the distal horizontal edge of the primary display device.

5. The gaming machine of claim 1, wherein the primary display device includes a plurality of primary display panels coupled together in a curved configuration.

6. The gaming machine of claim 1 further comprising an audio assembly including at least one audio output device oriented to direct audio output towards the primary display device, wherein the curvature of the primary display device is configured to guide the audio output towards the player area.

7. The gaming machine of claim 6, wherein the at least one audio output device is positioned adjacent to the distal horizontal edge and oriented towards the proximal horizontal edge.

8. The gaming machine of claim 6, wherein the audio assembly includes an internal audio output device positioned within an internal cavity of the cabinet and oriented to emit audio output through the primary display device towards the player area.

9. A gaming system comprising:
a gaming machine comprising:
a cabinet associated with a player area occupiable by players for play of a game at the gaming machine;
an input deck coupled to the cabinet and extending towards the player area, the input deck defining an input surface configured to receive player input; and
a presentation assembly coupled to the cabinet and oriented outward towards the player area, the presentation assembly comprising:
a primary display device conically curved around a vertical axis extending through at least one of the cabinet or the input deck, the primary display device having a concave curvature relative to the player area, and
wherein the primary display device has a distal horizontal edge and a proximal horizontal edge positioned between the input deck and the distal horizontal edge, the distal horizontal edge having a length and a radial length relative to the vertical axis greater than a respective length and a respective radial length relative to the vertical axis of the proximal horizontal edge; and
game-logic circuitry in communication with the presentation assembly, the game-logic circuitry configured to cause the primary display device of the presentation assembly to present game content of the game.

10. The gaming system of claim 9, wherein the input surface includes an input display device, and the proximal horizontal edge of the primary display device is positioned adjacent to the input display device.

11. The gaming system of claim 9, wherein the presentation assembly includes a secondary display device including a secondary distal horizontal edge and a secondary proximal horizontal edge, the secondary display device having a concave curvature relative to the player area, and wherein the secondary distal horizontal edge and the secondary proximal horizontal edge have substantially matching lengths.

12. The gaming system of claim 11, wherein the secondary distal horizontal edge is positioned adjacent to the distal horizontal edge of the primary display device.

13. The gaming system of claim 9, wherein the primary display device includes a plurality of primary display panels coupled together in a curved configuration.

14. The gaming system of claim 9 further comprising an audio assembly including at least one audio output device oriented to direct audio output towards the primary display device, wherein the curvature of the primary display device is configured to guide the audio output towards the player area.

15. The gaming system of claim 14, wherein the at least one audio output device is positioned adjacent to the distal horizontal edge and oriented towards the proximal horizontal edge.

16. The gaming system of claim 14, wherein the audio assembly includes an internal audio output device positioned within an internal cavity of the cabinet and oriented to emit audio output through the primary display device towards the player area.

17. A method of assembly for a gaming machine, the method comprising:
coupling an input deck to a cabinet of the gaming machine, the cabinet being associated with a player area occupiable by players for play of a game at the gaming machine and the input deck extending outward toward the player area, wherein the input deck defines an input surface configured to receive player input; and
coupling a presentation assembly to the cabinet, the presentation assembly being oriented outwards towards the player area and including a primary display device,
wherein the primary display device, with the presentation assembly coupled to the cabinet, is conically curved around a vertical axis extending through at least one of the cabinet or the input deck, the primary display device having a concave curvature relative to the player area, and
wherein the primary display device has a distal horizontal edge and a proximal horizontal edge positioned between the input deck and the distal horizontal edge, the distal horizontal edge having a length and a radial length relative to the vertical axis greater than a respective length and a respective radial length relative to the vertical axis of the proximal horizontal edge.

18. The method of claim 17, wherein the input surface includes an input display device, and the proximal horizontal edge of the primary display device is positioned adjacent to the input display device.

19. The method of claim 17 further comprising coupling a secondary display device of the presentation assembly to the cabinet, the secondary display device including a secondary distal horizontal edge and a secondary proximal horizontal edge adjacent to the display horizontal edge of the primary display device, the secondary display device having a concave curvature relative to the player area, and wherein the secondary distal horizontal edge and the secondary proximal horizontal edge have substantially matching lengths.

20. The method of claim 17 further comprising coupling an audio assembly to the cabinet, the audio assembly including at least one audio output device oriented to direct audio output towards the primary display device, wherein the curvature of the primary display device is configured to guide the audio output towards the player area.
